(19) United States
(12) Patent Application Publication
(10) Pub. No.: US 2014/0355255 A1
(43) Pub. Date: Dec. 4, 2014

(54) LIGHT EMITTING SHOE

(71) Applicant: CHENG-CHUNG HSU, TAICHUNG CITY (TW)

(72) Inventor: CHENG-CHUNG HSU, TAICHUNG CITY (TW)

(21) Appl. No.: 14/287,453

(22) Filed: May 27, 2014

(30) Foreign Application Priority Data
Jun. 3, 2013 (TW) 102210389

(51) Int. Cl. A43B 3/00; F21V 23/00

(52) U.S. Cl. CPC A43B 3/001; F21V 23/009
USPC 362/103

(57) ABSTRACT

A light emitting shoe has a shoe body and a light emitting module. The light emitting module is mounted in the shoe body and has a cell box, a controller, a light emitting unit and a switch. The cell box has a box base, a cell space, a cover, a first electrode and a second electrode. The cell space is formed in the box base and has an opening located at a top side of the box base. The cover is connected with the box base and selectively shelters the opening. The first electrode and the second electrode are mounted in the cell box. The controller is mounted in the shoe body and electrically connected with the first electrode and the second electrode. The light emitting unit and the switch are electrically connected with the controller. Replacing the cell mounted in the cell box is easy for a user.

### BACKGROUND OF THE INVENTION

1. Field of the Invention

The present invention relates to a light emitting shoe, and more particularly to a light emitting shoe that allows an user to replace the cell of the light emitting shoe easily.

2. Description of Related Art

Shoes are applied for protecting the feet of a user and are collocated with the clothing of the user for decorative and aesthetic effects. When the designs of shoes vary in style, the user's purchasing desire is enhanced. Therefore, to promote sales of shoes, a light emitting module is further mounted in the shoes to create a shining effect such that the appearance of the shoes is more eye-catching.

With reference to FIG. 9, a conventional light emitting shoe comprises a shoe body 50 and a light emitting module 60. The light emitting module 60 is mounted in the shoe body 50 and comprises a cell 61, a switch 62, a controller 63, and multiple light emitting units 64. The cell 61, the switch 62, the controller 63 and the light emitting units 64 are electrically connected with each other. The cell 61 supplies electric power to the controller 63 and the light emitting units 64. The switch 62 is controlled by a user to transmit a signal to the controller 63. Then, the controller 63 controls the light emitting units 64 to emit light. When the light emitting units 64 are lighted up, the lights emitted from the light emitting units 64 penetrate through the shoe body 50. Accordingly, the conventional light emitting shoe provides a dazzling visual effect.

However. replacing the cell 61 with another one is difficult since the cell 61 is assembled inside the shoe body 50. After the cell 61 runs out of electric power, the light emitting shoe can no longer emit light. Although the light emitting module 60 can be removably mounted in the shoe body 50 so as to resolve the described problem, the light emitting module 60 has to be designed in customization to fit shoes of different types, such that the manufacturing cost of the shoes is increased. On the other hand, as the retail price of the light emitting module 60 is increased due to the increased manufacturing cost, the user's motive to purchase a new light emitting module 60 to replace the original exhausted light emitting module 60 is also reduced.

### SUMMARY OF THE INVENTION

The main objective of the present invention is to provide a light emitting shoe that can resolve the problems of the conventional light emitting shoe.

The light emitting shoe comprises a shoe body and a light emitting module. The shoe body comprises a vamp comprising a bottom side, a sole base connected with the bottom side of the vamp and comprising a middle, an insole covering the sole base, and an accommodating space formed in the sole base and selectively sheltered by the insole.

The light emitting module is mounted in the shoe body and comprises a cell box, a controller, at least one light emitting unit and a switch. The cell box is mounted in the accommodating space and comprises a box base mounted in the accommodating space, a cell space formed in the box base and comprising an opening located at a top side of the box base, a cover connected with the box base and selectively sheltering the opening of the cell space, a first electrode mounted on the box base and comprising an end located in the cell space, and a second electrode mounted on the box base and comprising an end located in the cell space. The controller is mounted in the accommodating space and electrically connected with the first electrode and the second electrode. The at least one light emitting unit is electrically connected with the controller. The switch is mounted inside the vamp and electrically connected with the controller.

When a user wants to replace the original cell with a new one, the user just turns and lifts the insole to reveal the accommodating space and opens the cover to reveal the cell space, such that the user can remove the original cell from the cell space and put in a new one. Therefore, replacing the cell is easy and convenient for the user.

### BRIEF DESCRIPTION OF THE DRAWINGS

FIG. 1 is a perspective view of a preferred embodiment of a light emitting shoe in accordance with the present invention;

FIG. 2 is a side view in partial section of the light emitting shoe in FIG. 1;

FIG. 3 is a perspective view of a light emitting module in FIG. 1;

FIG. 4 is an enlarged exploded perspective view of the cell box in FIG. 3;

FIG. 5 is an enlarged exploded perspective view of another cell box;

FIG. 6 is an operational side view of the light emitting shoe in partial section in FIG. 1;

FIG. 7 is an operational perspective view of the light emitting shoe in FIG. 1;

FIG. 8 is an operational perspective view of the light emitting shoe in FIG. 1; and

FIG. 9 is a perspective view of a conventional light emitting shoe.

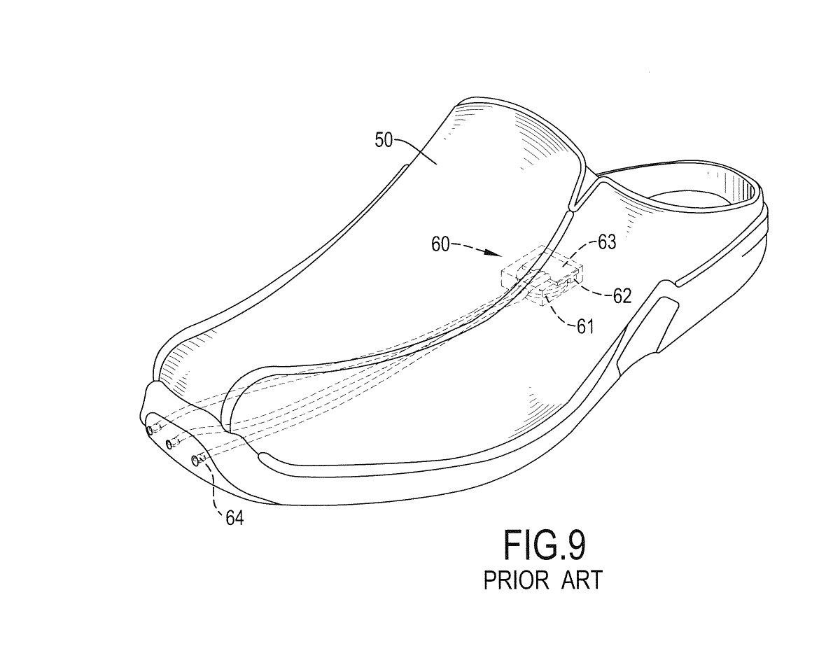

### DETAILED DESCRIPTION OF PREFERRED EMBODIMENT

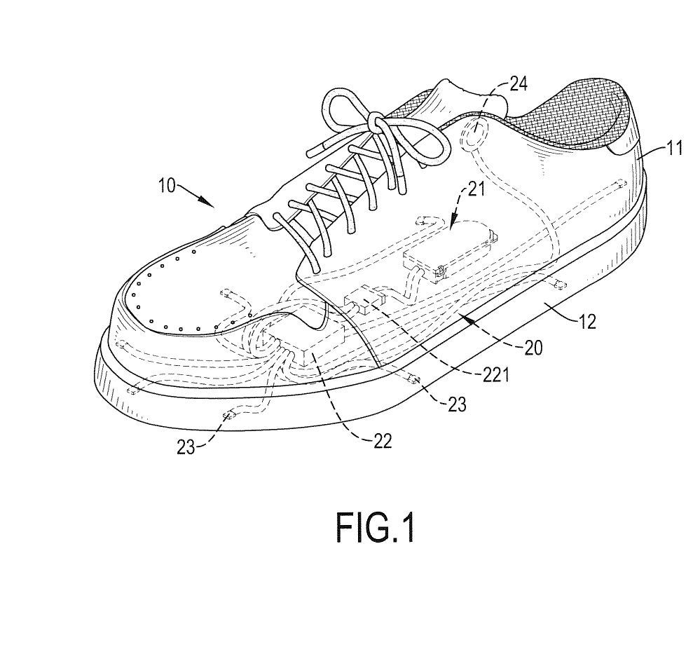

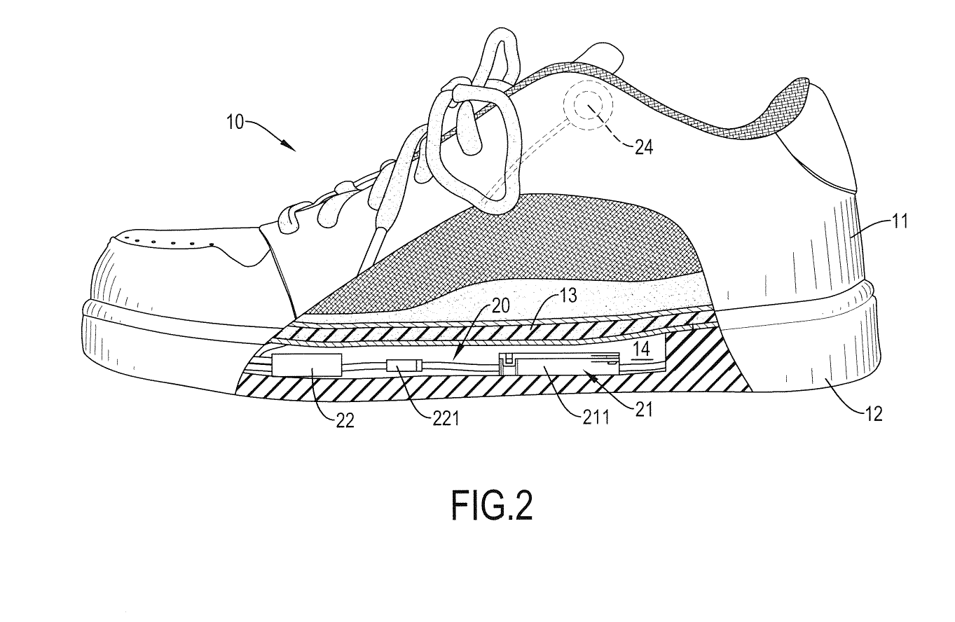

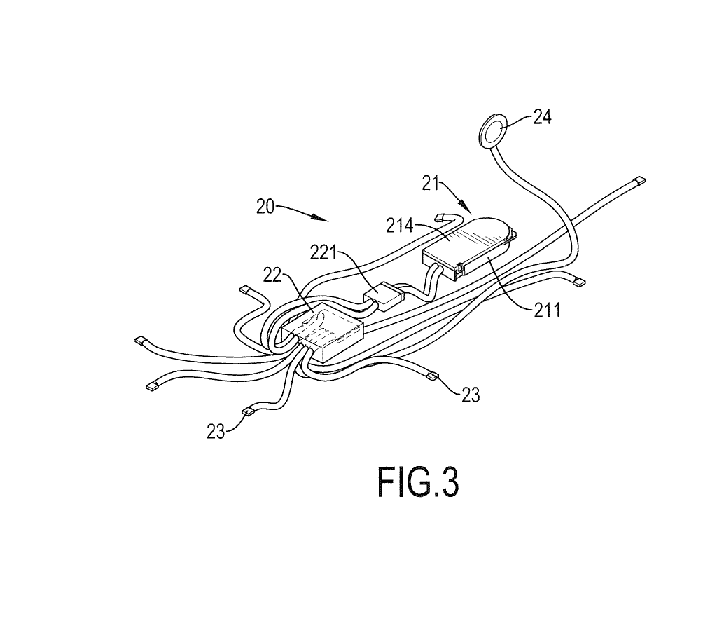

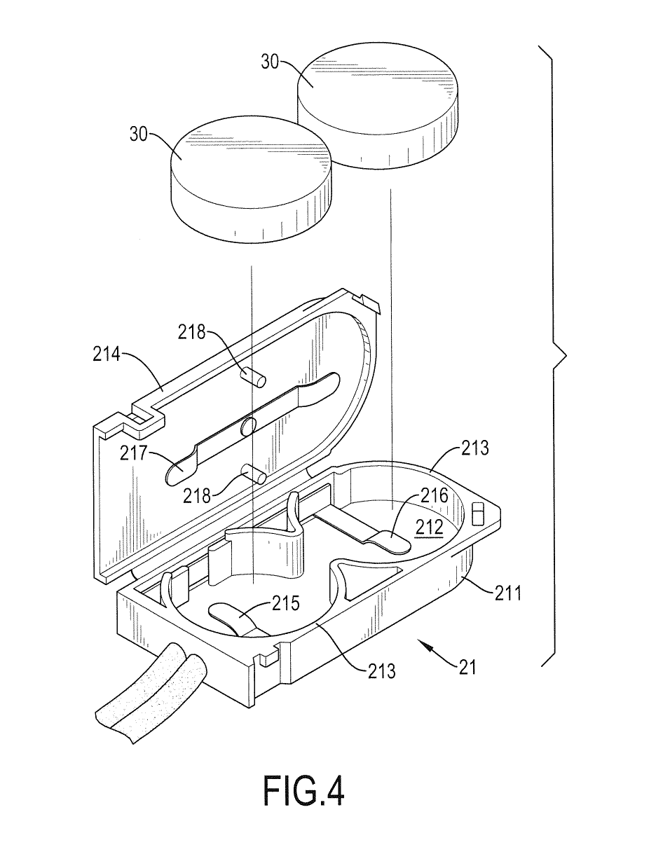

With reference to FIGS. 1 to 4, a preferred embodiment of a light emitting shoe in accordance with the present invention comprises a shoe body 10 and a light emitting module 20.

The shoe body 10 comprises a vamp 11, a sole base 12, an insole 13 and an accommodating space 14. The vamp 11 comprises a front end, a rear end, a right side and a left side. The sole base 12 is connected with a bottom side of the vamp 11 to form a wearable contour for a user. The insole 13 covers the sole base 12. The accommodating space 14 is formed in the sole base 12 and is sheltered by the insole 13. Preferably, the accommodating space 14 is formed in a middle of the sole base 12 corresponding to the position of the foot arch of the user.

The light emitting module 20 is mounted in the shoe body 10 and comprises a cell box 21, a controller 22, multiple light emitting units 23 and a switch 24. The cell box 21 is removably mounted in the accommodating space 14, wherein the accommodating space 14 is formed in the middle of the sole base 12 corresponding to the position of the foot arch of the user, such that the cell box 21 can be further prevented from being damaged by the treading force of the foot. The cell box 21 comprises a box base 211, a cell space 212, two positioning portions 213, a cover 214, a first electrode 215, a second electrode 216, a connecting piece 217 and two supporting pins 218. The box base 211 is elongated and comprises a front end, a rear end, a right side and a left side, wherein the front end, the rear end, the right side and the left side of the box base 211 respectively correspond in position to the front end, the rear end, the right side and the left side of the vamp 11. The cell space 212 is formed in the box base 211 and has an opening located at a top side of the box base 211. The positioning portions 213 are round, protrude from the box base 211 with an interval between each other, and are located in the cell space 212. The positioning portions 213 can hold the cells in position in the cell space 212. The cover 214 is connected with the top side of the box base 211 and selectively shelters the opening of the cell space 212. The cover 214 may be connected with the front end, the rear end, the right side or the left side of the box base 211. Preferably, the cover 214 is connected with the right side or the left side of the box base 211, such that when the user opens the cover 214 toward the right side of the left side of the box base 211, the hand of the user will not be stopped by a tongue of the light emitting shoe.

The first electrode 215 and the second electrode 216 are mounted in the box base 211. An end of the first electrode 215 and an end of the second electrode 216 are located in the cell space 212 respectively within areas surrounded by the positioning portions 213. The connecting piece 217 is mounted on the cover 214 and faces the cell space 212. The connecting piece 217 comprises a first end and a second end. The first end and the second end of the connecting piece 217 are located above the positioning portions 213 respectively. The supporting pins 218 protrude on the cover 214 and toward the cell space 212, wherein a length of each supporting pin 218 is equal to the height of the cell space 212, such that when the foot of the user presses the insole 13 and pressures the cell box 21 indirectly, the supporting pins 218 can provide a supporting force for the cell box 21 to protect the cell box 21 from being damaged.

The controller 22 is mounted in the accommodating space 14 and is electrically connected with the first electrode 215 and the second electrode 216. The controller 22 is connected with the first electrode 215 and the second electrode 216 by an adapting unit 221 that can be plugged and unplugged repeatedly, such that the adapting unit 221 can be unplugged to disconnect the cell box 21 from the controller 22 and the cell box 21 can further be removed from the accommodating space 14.

When two cells 30 are mounted in the cell space 212 respectively within the areas surrounded by the two positioning portions 213, the first electrode 215 is electrically connected with a negative electrode of one of the cells 30 and the controller 22, the second electrode 216 is electrically connected with a positive electrode of the other cell 30 and the controller 22, and the connecting piece 217 is electrically connected between the cells 30 to form an electrical loop.

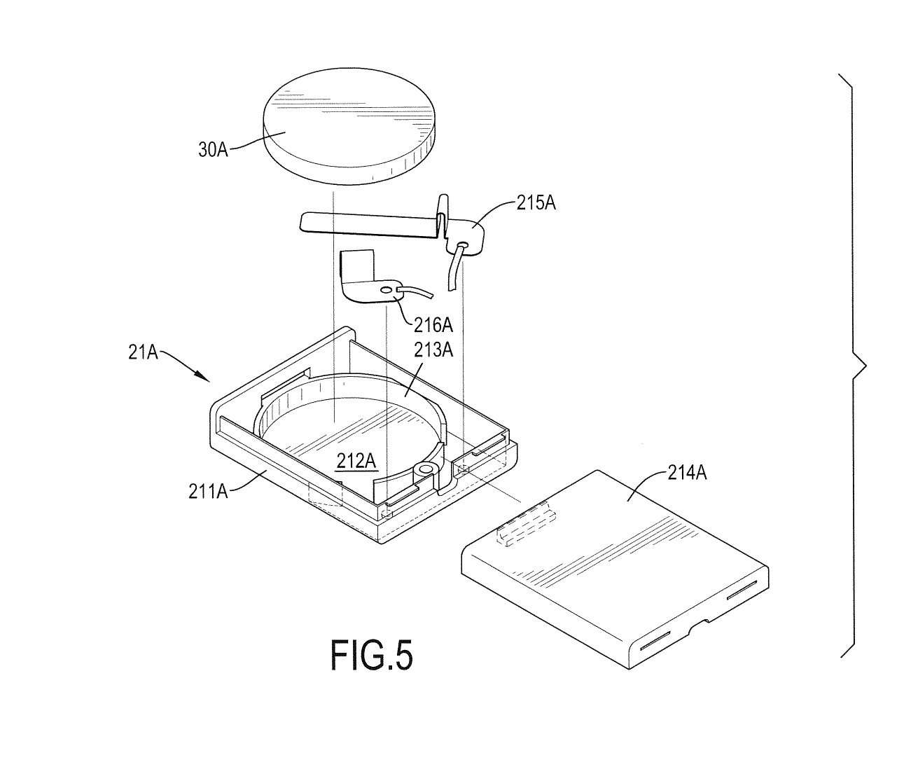

Further with reference to FIG. 5, alternatively, the connecting piece 217 may be omitted. Only one positioning portion 213A is implemented and only one cell 30A is mounted in the cell box 21A. The end of the first electrode 215A and the end of the second electrode 216A opposite to the controller 22 are located in the cell space 212A within the area surrounded by the positioning portion 213A and are electrically connected with the negative electrode and the positive electrode of the cell 30A respectively. Therefore, an electrical loop is formed between the controller 22, the first electrode 215A, the second electrode 216A and the cell 30. The cover 214A is mounted on the box base 211A to close the opening of the cell space 212A.

Alternatively, the positioning portions 213 may be omitted but two cells 30 are still mounted in the cell space 212. The end of the first electrode 215 and the end the second electrode 216 opposite to the controller 22 are arranged staggered from each other, such that the first electrode 215 and the second electrode 216 can be electrically connected with a negative electrode of one of the cells 30 and a positive electrode of the other cell 30 respectively. The connecting piece 217 is electrically connected between the cells 30. Therefore, an electrical loop is also formed between the controller 22, the cells 30, the first electrode 215, the second electrode 216 and the connecting piece 217.

The light emitting units 23 are electrically connected with the controller 22 and arranged along the periphery of the sole base 12. Alternatively, the light emitting units 23 may be densely mounted or concentrated at part(s) of the sole base 12. The switch 24 is mounted inside the vamp 11 and is electrically connected with the controller 22.

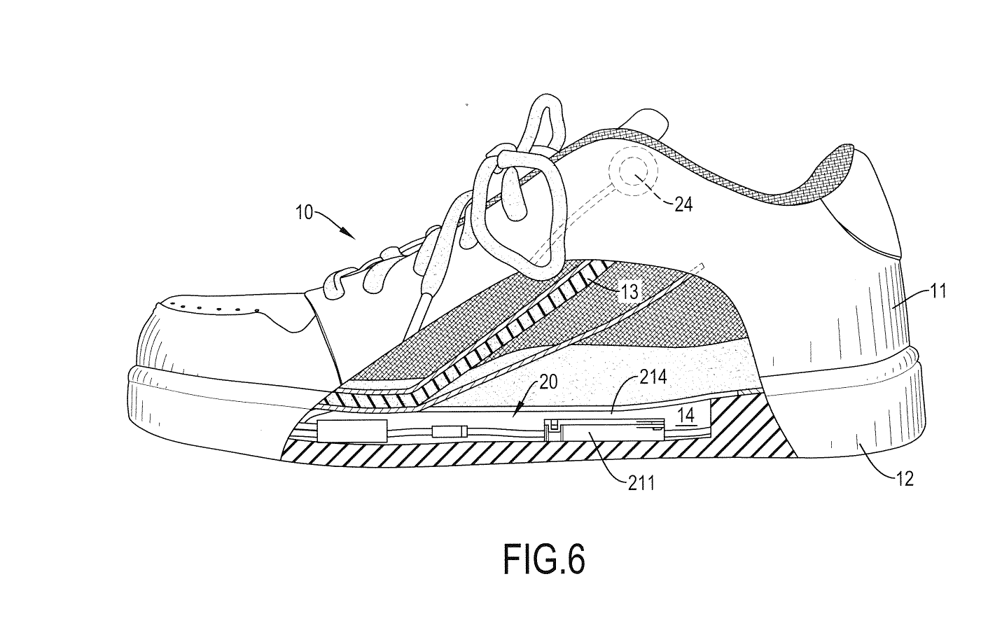

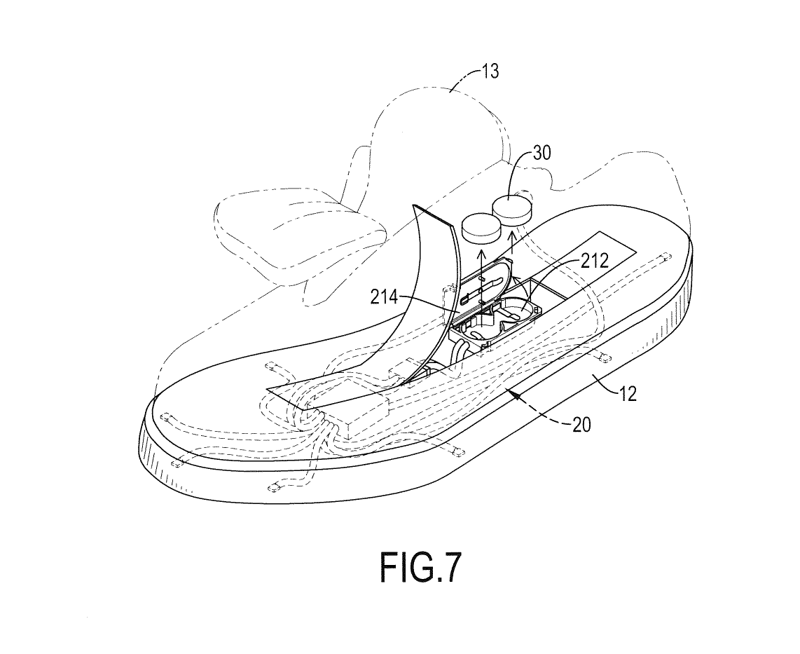

In use, a user presses the switch 24 to transmit a signal to the controller 22. The controller 22 can control the light emitting units 23 to emit light in different modes, such as a normal mode, a flicker mode, or a marquee mode. With reference to FIGS. 6 and 7, when the cells 30 runs out of electrical power, the cells 30 have to be replaced with new ones. First, the insole 13 is turned and lifted to reveal the accommodating space 14. Then, the cover 214 is opened to reveal the cell space 212 and the cells 30 mounted in the cell space 212 are removed from the cell space 212. After the original cells 30 are removed, the new cells 30 can be mounted in the cell space 212.

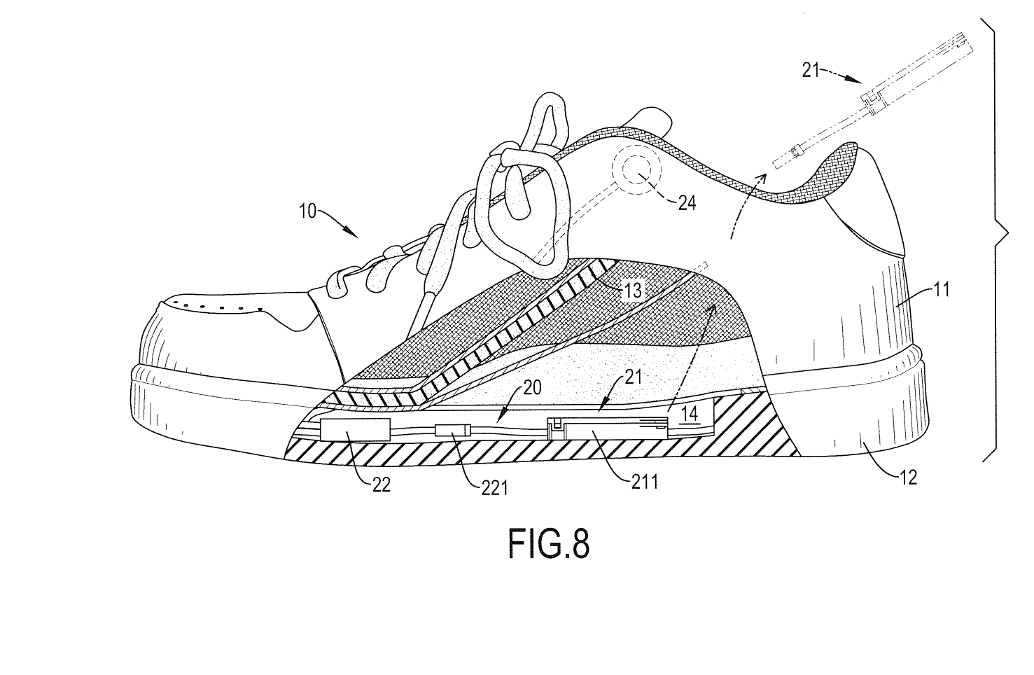

Alternatively, with reference to FIGS. 6 and 8, the cell box 21 can be removed from the accommodating space 14 after the insole 13 is lifted to reveal the accommodating space 14 since the cell box 21 is connected with the controller 22 by the adapting unit 221 that can be plugged and unplugged repeatedly. The user can disassemble the cell box 21 from the accommodating space 14 to replace the cells 30 or to clean the shoe body 10. The replacing steps for the cells 30 are simplified. Therefore, replacing the cells 30 is efficient and convenient for the user. Furthermore, the replacement cost can be decreased since the user only has to purchase new cells to replace the old ones instead of replacing the whole light emitting module 20. The light emitting module 20 can always maintain the light emitting effect as long as new cells 30 are provided, such that the life of the light emitting shoe can be prolonged. On the other hand. when the user wants to clean the shoe body 10, the user can remove the cell box 21 from the shoe body 10 to prevent the first electrode 215, the second electrode 216, and the connecting piece 217 from oxidizing, such that the life of the cell box 21 also can be prolonged.

What is claimed is:

1. A light emitting shoe comprising:
a shoe body comprising
a vamp comprising a bottom side;
a sole base connected with the bottom side of the vamp and comprising a middle;
an insole covering the sole base; and
an accommodating space formed in the middle of the sole base and selectively sheltered by the insole; and
a light emitting module mounted in the shoe body and comprising
a cell box mounted in the accommodating space and comprising
a box base mounted in the accommodating space;
a cell space formed in the box base and comprising an opening located at a top side of the box base;
a cover mounted on the box base and selectively sheltering the opening of the cell space;
a first electrode mounted on the box base and comprising an end located in the cell space; and
a second electrode mounted on the box base and comprising an end located in the cell space;
a controller mounted in the accommodating space and electrically connected with the first electrode and the second electrode;
at least one light emitting unit electrically connected with the controller; and
a switch mounted inside the vamp and electrically connected with the controller.

2. The light emitting shoe as claimed in claim 1, wherein
the end of the first electrode and the end of the second electrode opposite to the controller are arranged staggered from each other;
the cell box further comprises a connecting piece mounted on the cover facing the cell space and comprising a first end and a second end, wherein the first end corresponds in position to the first electrode and the second end corresponds in position to the second electrode.

3. The light emitting shoe as claimed in claim 2, wherein the cell box further comprises two positioning portions being round, protruding from the box base and located in the cell space, wherein
both the first end of the connecting piece and the end of the first electrode that is located in the cell space are within an area surrounded by one of the positioning portions; and
both the second end of the connecting piece and the end of the second electrode that is located in the cell space are within an area surrounded by the other positioning portion.

4. The light emitting shoe as claimed in claim 3, wherein the cell box further comprises two supporting pins protruding on the cover toward the cell space, and located out of the areas surrounded by the positioning portions, wherein a length of each supporting pin is equal to a height of the cell space.

5. The light emitting shoe as claimed in claim 4, wherein the light emitting module has multiple light emitting units arranged along a periphery of the sole base.

6. The light emitting shoe as claimed in claim 1, wherein the cell box is elongated, and the cover is connected with a side of the box base.

7. The light emitting shoe as claimed in claim 2, wherein the cell box is elongated, and the cover is connected with a side of the box base.

8. The light emitting shoe as claimed in claim 3, wherein the cell box is elongated, and the cover is connected with a side of the box base.

9. The light emitting shoe as claimed in claim 4, wherein the cell box is elongated, and the cover is connected with a side of the box base.

10. The light emitting shoe as claimed in claim 5, wherein the cell box is elongated, and the cover is connected with a side of the box base.

11. The light emitting shoe as claimed in claim 1, wherein
the controller is electrically connected with the first electrode and the second electrode by an adapting unit that can be plugged and unplugged repeatedly; and
the cell box is removably mounted in the accommodating space.

12. The light emitting shoe as claimed in claim 2, wherein
the controller is electrically connected with the first electrode and the second electrode by an adapting unit that can be plugged and unplugged repeatedly; and
the cell box is removably mounted in the accommodating space.

13. The light emitting shoe as claimed in claim 3, wherein
the controller is electrically connected with the first electrode and the second electrode by an adapting unit that can be plugged and unplugged repeatedly; and
the cell box is removably mounted in the accommodating space.

14. The light emitting shoe as claimed in claim 4, wherein
the controller is electrically connected with the first electrode and the second electrode by an adapting unit that can be plugged and unplugged repeatedly; and
the cell box is removably mounted in the accommodating space.

15. The light emitting shoe as claimed in claim 5, wherein
the controller is electrically connected with the first electrode and the second electrode by an adapting unit that can be plugged and unplugged repeatedly; and
the cell box is removably mounted in the accommodating space.

16. The light emitting shoe as claimed in claim 6, wherein
the controller is electrically connected with the first electrode and the second electrode by an adapting unit that can be plugged and unplugged repeatedly; and
the cell box is removably mounted in the accommodating space.

17. The light emitting shoe as claimed in claim 7, wherein
the controller is electrically connected with the first electrode and the second electrode by an adapting unit that can be plugged and unplugged repeatedly; and
the cell box is removably mounted in the accommodating space.

18. The light emitting shoe as claimed in claim 8, wherein
the controller is electrically connected with the first electrode and the second electrode by an adapting unit that can be plugged and unplugged repeatedly; and
the cell box is removably mounted in the accommodating space.

19. The light emitting shoe as claimed in claim 9, wherein
the controller is electrically connected with the first electrode and the second electrode by an adapting unit that can be plugged and unplugged repeatedly; and
the cell box is removably mounted in the accommodating space.

20. The light emitting shoe as claimed in claim 10, wherein
the controller is electrically connected with the first electrode and the second electrode by an adapting unit that can be plugged and unplugged repeatedly; and
the cell box is removably mounted in the accommodating space.
